(19) United States
(12) Patent Application Publication
(10) Pub. No.: US 2019/0384523 A1
(43) Pub. Date: Dec. 19, 2019

(54) CONTROL DEVICE, IMAGE FORMING APPARATUS INCORPORATING THE CONTROL DEVICE, CONTROL METHOD, AND NON-TRANSITORY RECORDING MEDIUM STORING PROGRAM

(71) Applicants: TAKASHI NAGUMO, Kanagawa (JP); ICHIRO KATSUNOI, Kanagawa (JP); AKIFUMI SATSUKA, Kanagawa (JP)

(72) Inventors: TAKASHI NAGUMO, Kanagawa (JP); ICHIRO KATSUNOI, Kanagawa (JP); AKIFUMI SATSUKA, Kanagawa (JP)

(73) Assignee: Ricoh Company, Ltd., Tokyo (JP)

(21) Appl. No.: 16/416,715

(22) Filed: May 20, 2019

(30) Foreign Application Priority Data
Jun. 18, 2018 (JP) 2018-115374

(51) Int. Cl. G06F 3/06; H04N 1/00

(52) U.S. Cl. CPC G06F 3/0647; G06F 3/0604; H04N 1/00206; G06F 3/0673; G06F 3/0659

(57) ABSTRACT

A control device for an image forming apparatus includes: a first transfer unit configured to read log data from a first memory and write the log data into a second memory; and a second transfer unit configured to read the log data from the second memory and transfer the log data outside the control device. The first memory is a volatile storage device and configured to store the log data acquired by a processor. The second memory is a volatile storage device. The first transfer unit, the second transfer unit, and the second memory are reset by a second reset unit other than a first reset unit configured to reset the processor and the first memory.

### CROSS-REFERENCE TO RELATED APPLICATION

This patent application is based on and claims priority pursuant to 35 U.S.C. § 119(a) to Japanese Patent Application No. 2018-115374, filed on Jun. 18, 2018, in the Japan Patent Office, the entire disclosure of which is hereby incorporated by reference herein.

### BACKGROUND

### Technical Field

Embodiments of the present disclosure relate to a control device, an image forming apparatus incorporating the control device, a control method, and a non-transitory recording medium storing program code for executing the control method.

### Description of the Related Art

Certain image forming apparatuses include an engine central processing unit (CPU) and a controller CPU. The engine CPU and the controller CPU are generally mounted on different boards divided between an engine CPU unit and a controller. The engine CPU mainly controls operations of an engine unit of the image forming apparatus and sensor data, and the controller CPU performs image processing and network processing.

With such a configuration, the engine CPU acquires log data of the engine unit and stores the log data in a volatile storage device to some extent. Subsequently, the stored log data is collectively transferred to a controller via a bus.

### SUMMARY

Embodiments of the present disclosure describes an improved control device for an image forming apparatus that includes: a first transfer unit configured to read log data from a first memory and write the log data into a second memory; and a second transfer unit configured to read the log data from the second memory and transfer the log data outside the control device. The first memory is a volatile storage device and configured to store the log data acquired by a processor. The second memory is a volatile storage device. The first transfer unit, the second transfer unit, and the second memory are reset by a second reset unit other than a first reset unit configured to reset the processor and the first memory.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram schematically illustrating an image forming apparatus according to a first embodiment of the present disclosure;

FIG. 2 is a block diagram illustrating the image forming apparatus according to the first embodiment;

FIG. 3 is a flowchart illustrating operations of collecting log data of the image forming apparatus according to the first embodiment;

FIG. 4 is a flowchart illustrating reset operations of the image forming apparatus according to the first embodiment;

FIG. 5 is a block diagram illustrating an image forming apparatus according to a comparative example;

FIG. 6 is a block diagram illustrating an image forming apparatus according to a second embodiment; and

FIG. 7 is a flowchart illustrating operations of collecting log data of the image forming apparatus according to the second embodiment.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

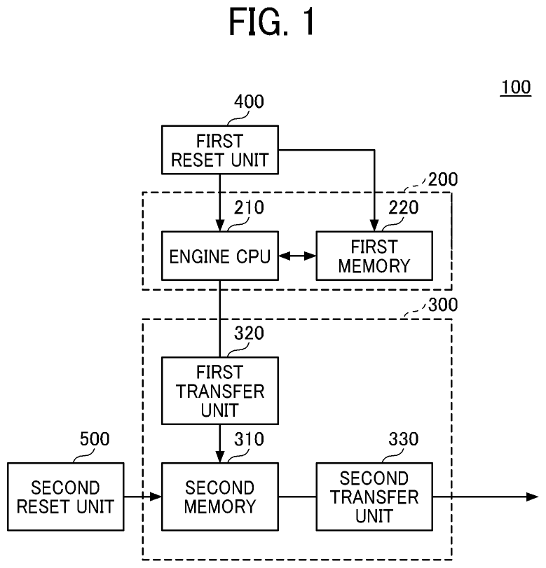

Descriptions are given of a first embodiment of the present disclosure with reference to the drawings. FIG. 1 schematically illustrates a configuration of an image forming apparatus 100 according to a first embodiment of the present disclosure.

The image forming apparatus 100 according to the present embodiment includes an engine CPU unit 200, an engine unit 300, a first reset unit 400, and a second reset unit 500. The engine CPU unit 200 includes an engine CPU (a processor) 210 and a first memory 220. The engine CPU 210 controls various operations of the engine unit 300. The engine CPU 210 acquires log data indicating a history of operations of the engine CPU 210 and the engine unit 300 and stores the log data in the first memory 220. As a certain amount of log data is accumulated in the first memory 220, the engine CPU 210 causes the engine unit 300 to read the log data stored in the first memory 220.

The first memory 220 is a volatile storage device such as a random access memory (RAM).

The engine unit 300 includes a second memory 310, a first transfer unit 320, and a second transfer unit 330. The second memory 310 is a volatile storage device such as a dynamic random access memory (DRAM).

The first transfer unit 320 reads the log data accumulated in the first memory 220 and writes the log data into the second memory 310 according to an instruction from the engine CPU 210.

As the first transfer unit 320 writes a certain amount of log data into the second memory 310, the second transfer unit 330 reads the log data stored in the second memory 310 and outputs the log data outside the engine unit 300. An output destination of the log data is, for example, a control unit to control the whole image forming apparatus 100.

The first reset unit 400 according to the present embodiment resets the engine CPU unit 200 when a reset of the engine CPU 210 is required due to failure of the image forming apparatus 100.

The second reset unit 500 according to the present embodiment resets the engine unit 300 when a reset of the engine unit 300 is required due to failure of the image forming apparatus 100.

That is, in the present embodiment, the first reset unit 400 resets the engine CPU 210, and the second reset unit 500 resets the engine unit 300. Therefore, the engine CPU unit 200 is in a first reset area that the first reset unit 400 resets, and the engine unit 300 is in a second reset area that the second reset unit 500 resets.

The first reset unit 400 and the second reset unit 500 may be instructed to reset, for example, by a host control unit of the engine CPU unit 200 and the engine unit 300. Specifically, for example, by an uppermost host control unit to control the whole image forming apparatus 100, the first reset unit 400 and the second reset unit 500 may be instructed to reset the first and second reset areas corresponding to the first reset unit 400 and the second reset unit 500, respectively.

Note that the engine CPU unit 200 and the engine unit 300 may be mounted either on physically different boards or on the same board.

In the present embodiment, as a certain amount of log data is accumulated in the first memory 220, the log data is transferred to the second memory 310 of the engine unit 300. In the present embodiment, the first reset unit 400 and the second reset unit 500 independently reset the engine CPU unit 200 and the engine unit 300, respectively.

Therefore, in the present embodiment, the first reset unit 400 resets only the engine CPU unit 200 if a reset of the engine CPU 210 is required due to failure of the image forming apparatus 100. As a result, according to the present embodiment, even when the engine CPU 210 is reset, the log data transferred to the second memory 310 is retained, and loss of the log data is prevented.

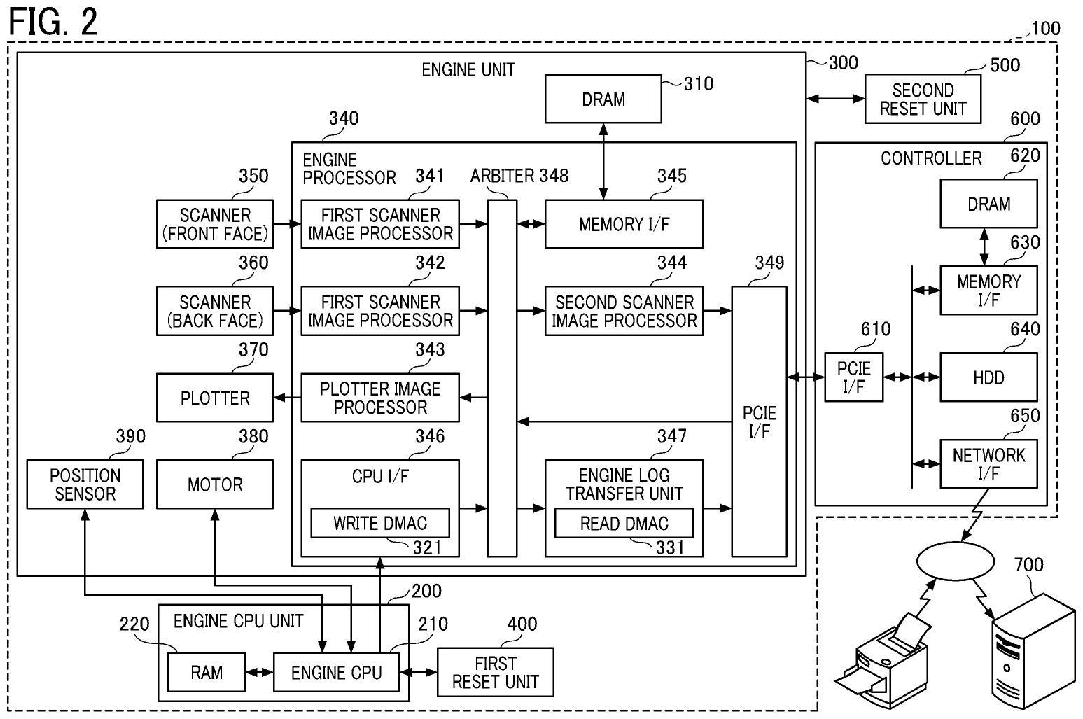

Next, the configuration of the image forming apparatus 100 according to the present embodiment is further described with reference to FIG. 2. FIG. 2 is a block diagram illustrating the image forming apparatus 100 according to the first embodiment.

The image forming apparatus 100 according to the present embodiment includes the engine CPU unit 200, the engine unit 300, and a controller 600.

The controller 600 are connected to the engine unit 300 by a peripheral component interconnect express (PCI express) bus.

The engine CPU unit 200 according to the present embodiment includes the engine CPU 210 and a RAM (the first memory) 220. The engine CPU 210 reads and executes a program stored in the RAM 220.

Further, the engine CPU 210 acquires log data indicating the history of operations of the engine unit 300 and the engine CPU 210 and stores the log data in the RAM 220. As the certain amount of the log data is stored in the RAM 220, the engine CPU 210 transfers the log data to the engine unit 300. More specifically, for example, as the number of times that the engine CPU 210 writes log data into the RAM 220 reaches a predetermined number of times (N times), the engine CPU 210 transfers the log data stored in the RAM 220 to the engine unit 300.

The engine unit 300 includes the DRAM (the second memory) 310, an engine processor 340, scanners 350 and 360, a plotter 370, a motor 380, and a position sensor 390. The engine unit 300 performs image reading by the scanners 350 and 360, image output by the plotter 370, and image processing by the engine processor 340.

The scanner 350 reads an image on a front face of an original document, and the scanner 360 reads an image on a back face of the original document. The plotter 370 forms an image on a recording medium based on image data output from the engine processor 340 and outputs the image.

The engine processor 340 according to the present embodiment includes first scanner image processors 341 and 342, a plotter image processor 343, a second scanner image processor 344, a memory interface (I/F) 345, a CPU I/F 346, an engine log transfer unit 347, an arbiter 348, and a peripheral component interconnect express (PCIe) I/F 349.

In the example in FIG. 2, the image forming apparatus 100 includes the two scanners 350 and 360, and the two first scanner image processors 341 and 342 to perform image processing on image data read by the scanners 350 and 360. In another example, an image forming apparatus may include only one scanner and one first scanner image processor.

The first scanner image processors 341 and 342 perform image processing depending on the scanners 350 and 360, and transfer image data after the image processing to the DRAM 310 via the arbiter 348 and the memory I/F 345. That is, the first scanner image processors 341 and 342 are third transfer units to transfer image data to the DRAM 310.

The plotter image processor 343 performs image processing for image formation. At that time, the plotter image processor 343 may read image data stored in the DRAM 310 via the arbiter 348 and the memory I/F 345, and may perform image processing on the image data.

The second scanner image processor 344 performs image processing independently of the scanners 350 and 360. At that time, the second scanner image processor 344 may read image data stored in the DRAM 310, perform image processing on the image data, and transfer the image data to the PCIe I/F 349.

The memory I/F 345 transfers data between the DRAM 310 and the engine processor 340.

The CPU I/F 346 transfers data to and from the engine CPU 210. Further, the CPU I/F 346 includes a write direct memory access controller (DMAC) 321 as the first transfer unit 320. The engine CPU 210 of the engine CPU unit 200 instructs the CPU I/F 346 to activate the write DMAC 321. When activated, the write DMAC 321 writes log data transferred from the engine CPU 210 via the arbiter 348 into the DRAM 310.

The engine log transfer unit 347 includes a read DMAC 331 as the second transfer unit 330 and transfers the log data stored in the DRAM 310 to the PCIe I/F 349. Specifically, the engine CPU 210 instructs the engine log transfer unit 347 to activate the read DMAC 331. When activated, the read DMAC 331 reads the log data from the DRAM 310 via the arbiter 348 and transfer the log data to the PCIe I/F 349.

The engine CPU 210 according to the present embodiment may activate the read DMAC 331, for example, when the number of times that the write DMAC 321 writes log data into the DRAM 310 reaches a certain number of times (M times). Here, the certain number of times (M times) is smaller than the predetermined number of times (N times).

The arbiter 348 arbitrates access to the DRAM 310 from the various units described above. The PCIe I/F 349 transfers data between the engine unit 300 and the controller 600. That is, the second transfer unit 330 to transfer log data stored in the DRAM 310 outside the engine unit 300 includes the PCIe I/F 349.

The controller 600 includes a PCIe I/F 610, a DRAM 620, a memory I/F 630, a hard disk drive (HDD) 640, and a network I/F 650.

The PCIe I/F 610 transfers data to and from the PCIe I/F 349 of the engine unit 300. The DRAM 620 as a third memory stores image data and log data transferred to the controller 600. The memory I/F 630 transfers data to and from the DRAM 620.

The HDD 640 as the third memory stores various data transferred to the controller 600, data acquired by the image forming apparatus 100 via the network I/F 650, and the like.

The network I/F 650 is an interface to connect the image forming apparatus 100 to a network. The image forming apparatus 100 can be connected to the network via the network I/F 650 and communicate with a server 700 on the network.

A description is given of operations when the image forming apparatus 100 reads images by the scanners 350 and 360.

In the image forming apparatus 100, the scanners 350 and 360 read images on the front face and back face of the original document, respectively, and output the image data to the first scanner image processors 341 and 342, respectively. The first scanner image processors 341 and 342 perform image processing depending on the scanners 350 and 360 on the image data input from the scanners 350 and 360, and transfer the image data after the image processing to the memory I/F 345 via the arbiter 348. The memory I/F 345 stores the received image data in the DRAM 310.

At that time, since the image forming apparatus 100 includes the two first scanner image processors 341 and 342, image data transfers from the first scanner image processors 341 and 342 to the DRAM 310 occur almost simultaneously.

The second scanner image processor 344 reads the image data stored in the DRAM 310 via the memory I/F 345 and the arbiter 348, and performs image processing independently of the scanners 350 and 360. The second scanner image processor 344 transfers the processed image data to the PCIe I/F 349. The PCIe I/F 349 transfers the received image data to the controller 600.

The image forming apparatus 100 includes only the one second scanner image processor 344. Accordingly, the PCIe I/F 349 transfers image data of the back face of the recording medium read by the scanner 360 to the controller 600 after transferring image data of the front face of the recording medium read by the scanner 350 to the controller 600.

Receiving the image data, the controller 600 stores the image data in the DRAM 620 via the memory I/F 630. Subsequently, the controller 600 performs image processing on the image data stored in the DRAM 620 by application, stores the image data in the HDD 640, or output the image data to the server 700 via the network I/F 650. The server 700 according to the present embodiment has, for example, a function to predict failure of the image forming apparatus 100, and the log data according to the present embodiment may be used to predict failure of the image forming apparatus 100.

Next, a description is given of operations of the image forming apparatus 100 when the plotter 370 outputs images formed on the recording medium.

For example, when image data input from outside the image forming apparatus 100 is output from the plotter 370 (i.e., printing function), the image forming apparatus 100 loads the image data input via the network I/F 650 of the controller 600 to the memory I/F 630.

When image data acquired by the scanners 350 and 360 is output from the plotter 370, the image forming apparatus 100 loads the image data stored in the DRAM 620 of the controller 600 to the memory I/F 630. The memory I/F 630 transfers the loaded image data to the engine processor 340 of the engine unit 300 via the PCIe I/F 610.

As the PCIe I/F 349 receives the image data from the controller 600, the engine processor 340 writes the image data into the DRAM 310 by the PCIe I/F 349 via the memory I/F 345.

As the image data is written in the DRAM 310, the engine processor 340 reads the image data from the DRAM 310 by the plotter image processor 343. The plotter image processor 343 performs image processing on the image data and outputs the image data after the image processing to the plotter 370.

In the present embodiment, the PCIe I/F 349 may include a write DMAC and write image data to the DRAM 310 by the write DMAC. In addition, the plotter image processor 343 according to the present embodiment may include a read DMAC and read image data from the DRAM 310 by the read DMAC. Thus, both log data and image data are written into the DRAM 310 according to the present embodiment.

In the present embodiment, when the image data is written into or read from the DRAM 310, the first scanner image processors 341 and 342, and the plotter image processor 343 are the third transfer units to transfer image data to or from the DRAM 310. In the present embodiment, the PCIe I/F 349 to transfer image data to the controller 600 is a fourth transfer unit.

In the present embodiment, since the image data received from the controller 600 is stored in the DRAM 310 once, an amount of image data to be transferred from the engine processor 340 to the plotter 370 can be maintained, for example, even if transfer bandwidth drops in the PCIe bus.

Therefore, for example, when the PCIe bus has sufficient transfer bandwidth, image data transferred from the controller 600 to the engine unit 300 does not have to be temporarily stored in the DRAM 310.

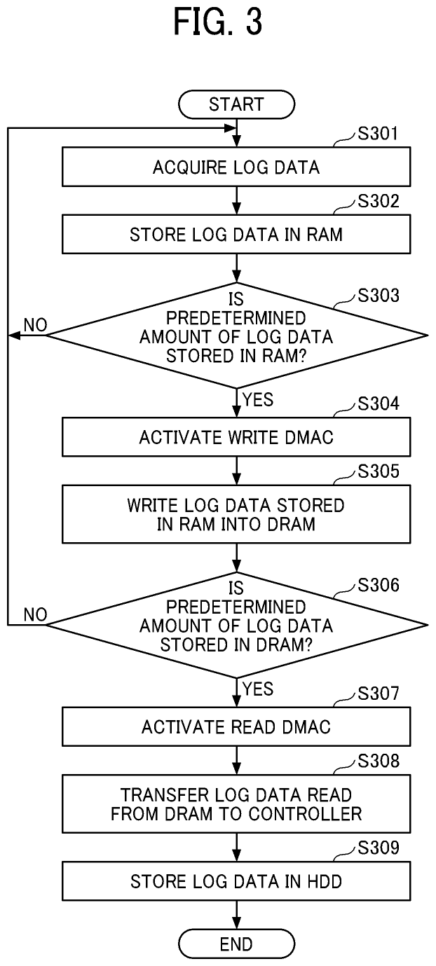

Next, with reference to FIG. 3, a description is given of operations to collect log data in the image forming apparatus 100 according to the present embodiment. FIG. 3 is a flowchart illustrating operations of collecting the log data in the image forming apparatus 100 according to the first embodiment.

In the image forming apparatus 100 according to the present embodiment, the engine CPU 210 of the engine CPU unit 200 acquires log data of the engine unit 300 and the engine CPU 210 (step S301).

A description is given below of log data according to the present embodiment. In the engine CPU 210 according to the present embodiment, the log data may include data acquired from the motor 380 and the position sensor 390 included in the engine unit 300. Specifically, the engine CPU 210 acquires, for example, data indicating a rotation speed and/or a driving state of the motor 380 as the log data. Further, the engine CPU 210 may acquire data indicating a position, which is detected by the position sensor 390, of the recording medium conveyed in the image forming apparatus 100. In other words, the log data according to the present embodiment may include signals output from various sensors to detect states of the image forming apparatus 100.

Subsequently, the image forming apparatus 100 stores the log data acquired by the engine CPU 210 in the RAM 220 of the engine CPU unit 200 (step S302).

Next, the engine CPU 210 determines whether a predetermined amount of log data has been stored in the RAM 220 (step S303). Specifically, the engine CPU 210 determines whether the log data has been written into the RAM 220 N times.

In step S303, if the predetermined amount of log data has not been stored in the RAM 220, the process returns to step S301.

In step S303, if the predetermined amount of log data has been stored in the RAM 220, the engine CPU 210 activates the write DMAC 321 of the engine processor 340 (step S304). Next, the engine CPU 210 causes the write DMAC 321 to read the log data stored in the RAM 220 and store the log data in the DRAM 310 (step S305).

Then, the engine CPU 210 determines whether the write DMAC 321 has stores the predetermined amount of log data in the DRAM 310 (step S306). Specifically, the engine CPU 210 determines whether the write DMAC 321 has written into the DRAM 310 M times.

Note that, M is smaller than N, and M and N are integers.

In step S306, if the predetermined amount of log data has not been stored in the DRAM 310, the process returns to step S301.

In step S306, if the predetermined amount of log data has been stored in the DRAM 310, the engine CPU 210 activates the read DMAC 331 (step S307). Next, the engine CPU 210 causes the read DMAC 331 to read the log data stored in the DRAM 310 and transfer the log data to the controller 600 (step S308).

Subsequently, as the controller 600 of the image forming apparatus 100 receives the log data via the PCIe I/F 610, the controller 600 stores the log data in the DRAM 620 and/or the HDD 640 (step S309), and the process ends.

Thus, in the present embodiment, as the log data has been written into the RAM 220 N times, the write DMAC 321 transfers the log data stored in the RAM 220 to the DRAM 310. Further, in the present embodiment, as the log data has been written into the DRAM 310 M times, the read DMAC 331 transfers the log data stored in the DRAM 310 to the controller 600.

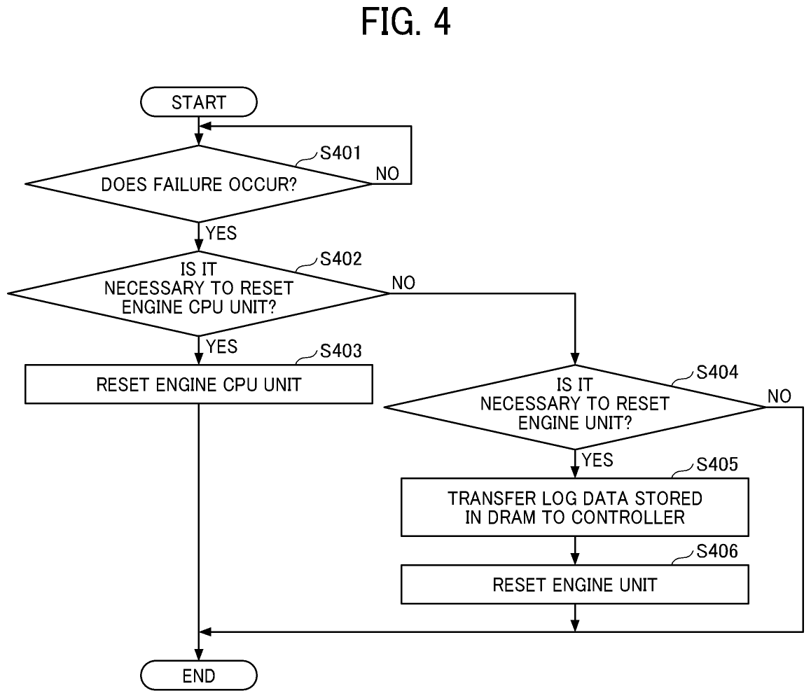

Next, with reference to FIG. 4, reset operations in the image forming apparatus 100 according to the present embodiment are described. FIG. 4 is a flowchart illustrating reset operations in the image forming apparatus 100 according to the first embodiment.

The image forming apparatus 100 according to the present embodiment determines whether a failure has occurred in the image forming apparatus 100 (step S401). The occurrence of a failure may be detected by the control unit that controls the whole image forming apparatus 100.

In step S401, if a failure has not occurred, the image forming apparatus 100 remains in a standby state.

In step S401, if a failure has occurred, the image forming apparatus 100 determines whether to reset the engine CPU unit 200 (step S402). Specifically, the image forming apparatus 100 determines whether to reset the engine CPU 210, for example, when the engine CPU 210 freezes.

In step S402, if the image forming apparatus 100 determines to reset the engine CPU unit 200, the first reset unit 400 resets the engine CPU 210 of the engine CPU unit 200 (step S403), and the process ends.

In step S402, if the image forming apparatus 100 determines not to reset the engine CPU unit 200, the image forming apparatus 100 determines whether to reset the engine unit 300 (step S404).

In step S404, if the image forming apparatus 100 determines to reset the engine unit 300, the read DMAC 331 of the engine processor 340 transfers the log data stored in the DRAM 310 to the controller 600 (step S405). Then, the second reset unit 500 resets the engine unit 300 (step S406), and the process ends.

As described above, in the present embodiment, the engine CPU unit 200 and the engine unit 300 are reset independently. In other words, the engine processor 340 according to the present embodiment is a control device including the write DMAC 321 and the read DMAC 331. The engine CPU 210 and the RAM 220 of the engine CPU unit 200 are reset by one reset unit (i.e., the first reset unit 400), and the engine unit 300 is reset by another reset unit (i.e., the second reset unit 500).

Therefore, in the present embodiment, even when the engine CPU 210 is reset, the log data stored in the DRAM 310 is not lost but is retained. As a result, for example, when the engine CPU 210 is reset immediately after the log data stored in the RAM 220 is written into the DRAM 310, the log data immediately before any failure requiring the engine CPU 210 to be reset, is not lost.

Further, in the present embodiment, the log data stored in the DRAM 310 is transferred to the controller 600 before the engine unit 300 is reset. As a result, according to the present embodiment, loss of the log data stored in the DRAM 310 is prevented immediately before any failure that requires the engine unit 300 to be reset. Further, in the present embodiment, even when the engine unit 300 is reset, the log data stored in the RAM 220 of the engine CPU unit 200 is not deleted. As a result, the log data can be maintained in the RAM 220 when any failure that requires the engine unit 300 to be reset occurs.

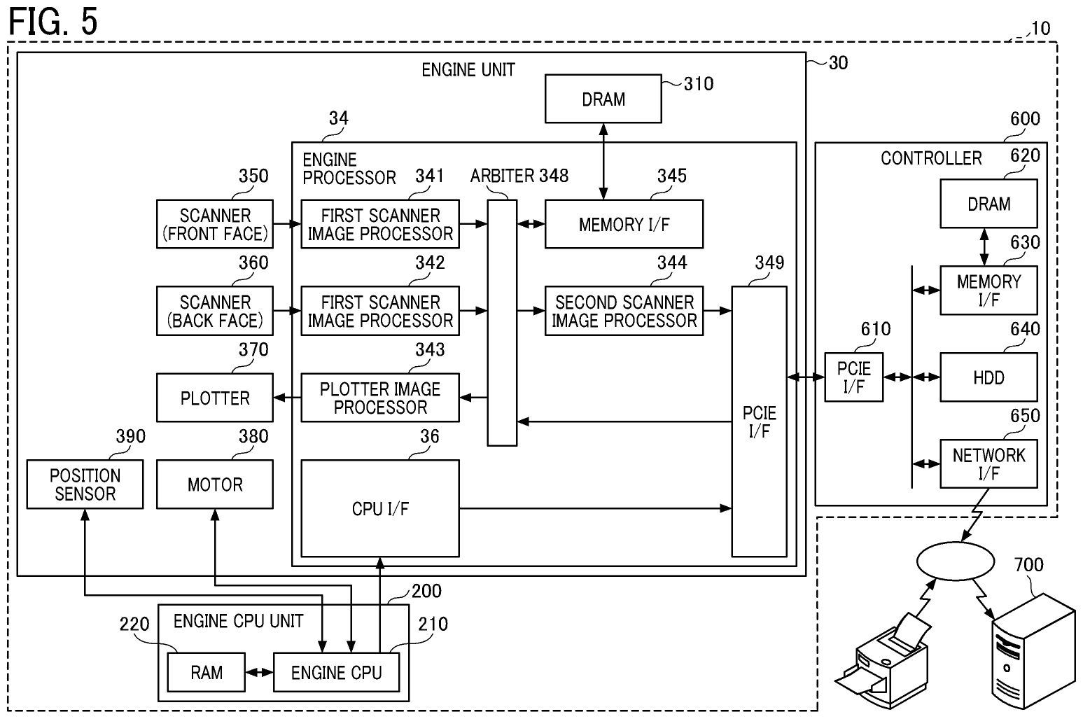

A description is given of effects according to the present embodiment with reference to a comparative example in FIG. 5.

FIG. 5 is a block diagram illustrating the comparative example.

An image forming apparatus 10 illustrated in FIG. 5 includes an engine unit 30, the engine CPU unit 200, and the controller 600.

An engine processor 34 of the engine unit 30 does not include the engine log transfer unit 347. A CPU I/F 36 of the engine processor 34 does not include the write DMAC 321.

In the example in FIG. 5, as the engine CPU 210 acquires log data from the motor 380 or the position sensor 390, the log data is temporarily stored in the RAM 220. In the image forming apparatus 10, as a predetermined amount of log data has been stored in the RAM 220, the PCIe I/F 349 accesses the controller 600 and write the log data stored in the RAM 220 into the DRAM 620 via the PCIe bus.

With this configuration, the bandwidth of the PCIe bus is subsumed by the log data transfer. As a result, for example, when image data is transferred to the controller 600 via the PCIe bus, the log data is required to wait to be transferred until the image data has been transferred. Accordingly, a lot of log data is accumulated in the RAM 220. Consequently, if the engine CPU 210 is reset due to failure, a lot of log data is lost.

In contrast, in the present embodiment, the log data is transferred to the DRAM 310, and the engine CPU unit 200 and the engine unit 300 are separately reset. As a result, in the present embodiment, even if the log data is not transferred to the controller 600, the log data is not lost. Further, in the present embodiment, log data that equals or exceeds burst transmission of the PCIe bus per minute can be transferred to the controller 600 all at once using the write DMAC 321 and the read DMAC 331. Therefore, the log data can be efficiently transferred.

A description is given of a second embodiment of the present disclosure with reference to the drawings. The second embodiment differs from the first embodiment in that transfer of image data is prioritized over transfer of log data. Note that, in the following description of the second embodiment, only differences from the first embodiment are described. Elements that function similarly to the elements according to the first embodiment are given reference numerals similar to those in the first embodiment, and redundant descriptions are omitted.

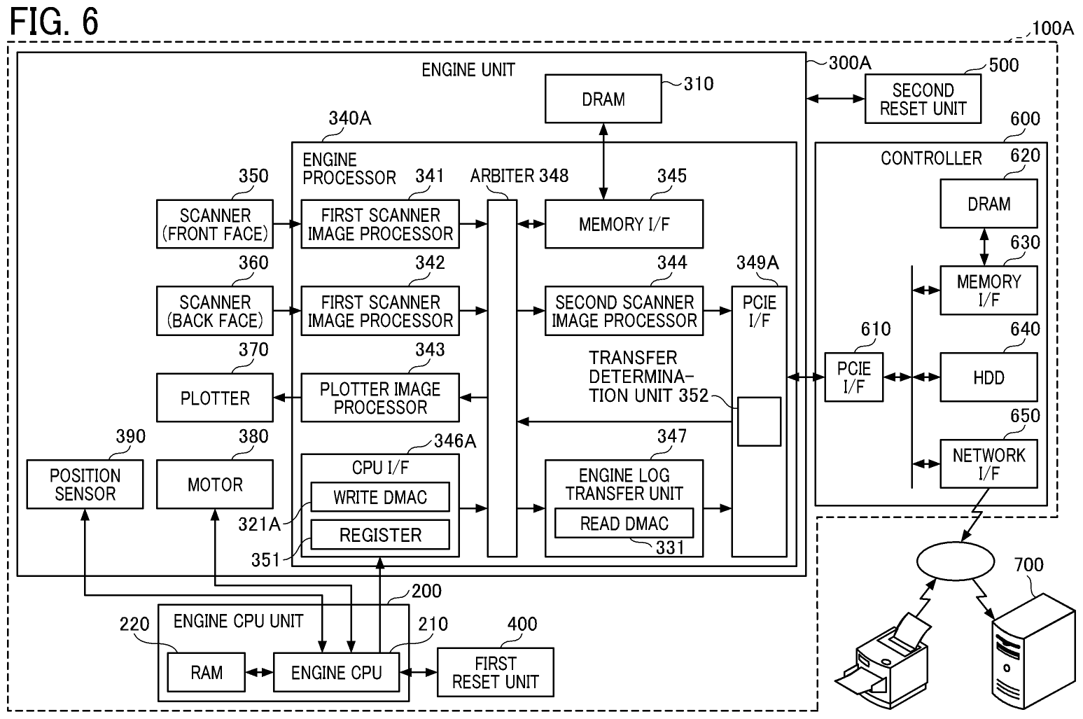

FIG. 6 is a block diagram illustrating an image forming apparatus 100A according to the second embodiment. The image forming apparatus 100A according to the present embodiment includes an engine unit 300A. The engine unit 300A includes an engine processor 340A.

The engine processor 340A includes a CPU I/F 346A and a PCIe I/F 349A.

The CPU I/F 346A includes a write DMAC 321A and the register 351. The write DMAC 321A writes log data into the DRAM 310 when a value of the register 351 is equal to a set value.

When the engine processor 340A transfers image data, a value indicating that image data transfer is in progress is set to the register 351. When the engine processor 340A does not transfer image data, a value indicating that the engine processor 340A does not transfer image data is set to the register 351. The engine CPU 210 may set the value of the register 351.

The write DMAC 321A according to the present embodiment refers to the value of the register 351 and transfers log data stored in the RAM 220 to the DRAM 310.

The PCIe I/F 349A includes a transfer determination unit 352. The transfer determination unit 352 determines whether to allow log data transfer from the engine processor 340A to the controller 600. Specifically, the transfer determination unit 352 determines that the log data transfer is allowed when the PCIe I/F 349A does not transfer image data.

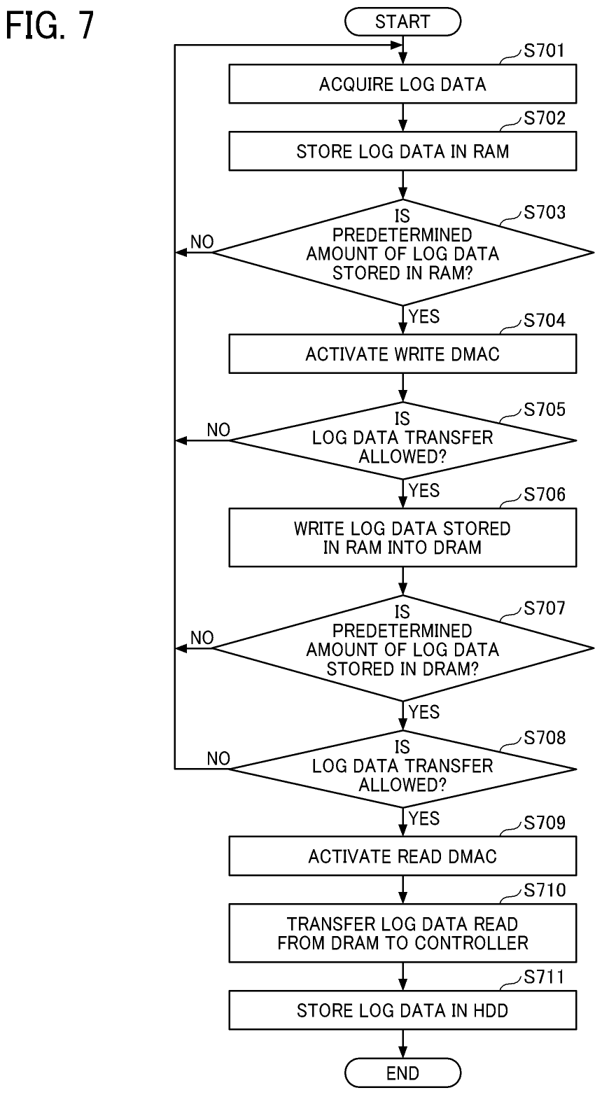

Next, with reference to FIG. 7, operations of the image forming apparatus 100A according to the present embodiment are described. FIG. 7 is a flowchart illustrating operations of collecting log data of the image forming apparatus 100A according to the second embodiment.

The processing of steps S701 to S704 illustrated in FIG. 7 is the same as the processing of steps S301 to S304 illustrated in FIG. 3.

In step S704, after activated, the write DMAC 321A refers to the register 351 and determines whether to allow to write log data into the DRAM 310 (step S705). Specifically, the write DMAC 321A determines whether the value of the register 351 is a value indicating that writing of the image data is in progress.

In step S705, when the writing of the log data is not allowed, that is, when the engine processor 340A writes image data into the DRAM 310, the process returns to step S701. In step S705, when the writing of the log data is allowed, that is, when the engine processor 340A does not write image data into the DRAM 310, the process goes to step S706.

Since the processing of steps S706 and S707 illustrated in FIG. 7 is the same as the processing of steps S305 and S306 illustrated in FIG. 3, descriptions of steps S706 and S707 are omitted.

In step S707, as the predetermined amount of log data has been stored in the DRAM 310, the transfer determination unit 352 of the PCIe I/F 349A determines whether log data is allowed to be transferred to the controller 600 (step S708). Specifically, the transfer determination unit 352 determines whether the PCIe I/F 349A is transferring image data.

In step S708, when the log data transfer is not allowed, that is, when the PCIe I/F 349A transfers image data, the process returns to step S701.

In step S708, when the log data transfer is allowed, that is, when the PCIe I/F 349A does not transfer image data, the process goes to step S709. Since the processing of steps S709 to S711 illustrated in FIG. 7 is the same as the processing of steps S307 to S309 illustrated in FIG. 3, descriptions of steps S709 to S711 are omitted.

In the example in FIG. 7, the log data is not transferred when the engine processor 340A transfers the image data, but processing is not limited to the above described example.

The write DMAC 321A and the read DMAC 331 according to the present embodiment have a function to change the bandwidth of log data transfer. When the image data is transferred, log data may be transferred in a bandwidth that does not affect the image data transfer.

Specifically, in step S705, when the image data is transferred, the write DMAC 321A may write the log data into the DRAM 310 in a bandwidth narrower than when image data is not transferred. Further, in step S708, when the image data is transferred, the read DMAC 331 may transfer the log data read from the DRAM 310 to the PCIe I/F 349A in a bandwidth narrower than when image data is not transferred.

As described above, in the present embodiment, the image data transfer using the DRAM 310 is prioritized over the log data transfer, thereby reading and outputting images quickly.

In the present embodiment, the log data is transferred to the controller 600 when the image data is not transferred, but processing is not limited to the above described example.

In the present embodiment, log data may be transferred to the controller 600 at each predetermined interval regardless of the image data transfer.

In this case, a counter may be provided instead of the register 351. The write DMAC 321A may be allowed to write log data into the DRAM 310 each time the counter counts a predetermined number. At that time, the PCIe I/F 349A may transfer image data and log data in a time-divided manner.

The above-described embodiments are illustrative and do not limit the present disclosure. Thus, numerous additional modifications and variations are possible in light of the above teachings. It is therefore to be understood that within the scope of the present disclosure, the present disclosure may be practiced otherwise than as specifically described herein. The number, position, and shape of the components described above are not limited to those embodiments described above. Desirable number, position, and shape can be determined to perform the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A control device for an image forming apparatus, the control device comprising:
a first transfer unit configured to read log data from a first memory and write the log data into a second memory, the first memory configured to store the log data acquired by a processor, the first memory being a volatile storage device, the second memory being a volatile storage device; and
a second transfer unit configured to read the log data from the second memory and transfer the log data outside the control device,
the first transfer unit, the second transfer unit, and the second memory configured to be reset by a second reset unit other than a first reset unit configured to reset the processor and the first memory.

2. An image forming apparatus comprising:
the control device according to claim 1;
a first reset area in which the processor and the first memory are mounted; and
a second reset area in which the first transfer unit, the second transfer unit, and the second memory are mounted,
wherein the first reset unit is configured to reset the first reset area, and
wherein the second reset unit is configured to reset the second reset area.

3. The image forming apparatus according to claim 2,
wherein the first transfer unit is configured to read the log data stored in the first memory and write the log data into the second memory when a number of times that the processor writes the log data into the first memory reaches a predetermined number of times, and
wherein the second transfer unit is configured to transfer the log data stored in the second memory, outside the control device when a number of times that the first transfer unit writes the log data into the second memory reaches a certain number of times that is smaller than the predetermined number of times.

4. The image forming apparatus according to claim 2, further comprising a third memory disposed outside the second reset area,
wherein the second transfer unit is configured to transfer the log data stored in the second memory to the third memory before the second reset unit resets the second reset area.

5. The image forming apparatus according to claim 4, further comprising a sensor configured to detect a state of the image forming apparatus,
wherein the log data includes a signal output from the sensor.

6. The image forming apparatus according to claim 4, further comprising a third transfer unit configured to transfer image data to the second memory,
wherein the second transfer unit is configured to transfer the image data stored in the second memory to the third memory.

7. The image forming apparatus according to claim 6,
wherein the second transfer unit is configured to prioritize transfer of the image data over transfer of the log data.

8. A control method for controlling a control device, the method comprising:
log storing processing including:
acquiring log data; and
storing the log data in a first volatile memory;
first transfer processing including:
reading the log data stored in the first volatile memory; and
storing the log data in a second volatile memory;
second transfer processing including:
reading the log data from the second volatile memory; and
transferring the log data outside the control device;
resetting a part of the control device that executes the log storing processing; and
resetting another part of the control device that executes the first transfer processing and the second transfer processing.

9. A non-transitory recording medium storing program code which, when executed by one or more processors, causes the one or more processors to perform a method for controlling a control device, the method comprising:
log storing processing including:
acquiring log data; and
storing the log data in a first volatile memory;
first transfer processing including:
reading the log data stored in the first volatile memory; and
storing the log data in a second volatile memory;
second transfer processing including:
reading the log data from the second volatile memory; and
transferring the log data outside the control device;
resetting a part of the control device that executes the log storing processing; and
resetting another part of the control device that executes the first transfer processing and the second transfer processing.
